(19) United States
(12) Patent Application Publication
(10) Pub. No.: US 2023/0418950 A1
(43) Pub. Date: Dec. 28, 2023

(54) Methods, Devices, and Systems for Control Flow Integrity

(71) Applicant: Synamedia Limited, Staines Upon Thames (GB)

(72) Inventors: Uri Porat, Modiin (IL); Yair Philipson, Jerusalem (IL)

(21) Appl. No.: 17/848,339

(22) Filed: Jun. 23, 2022

(51) Int. Cl. G06F 21/57; G06F 21/54; G06F 21/60

(52) U.S. Cl. CPC G06F 21/577; G06F 21/54; G06F 21/602

(57) ABSTRACT

Techniques for control flow integrity (CFI) performed at device(s) are described herein. In some embodiments, an extended compilation process is performed at memory unit(s) for storing instructions corresponding to compiled source codes and/or modified codes and an extended compiler unit. The extended compiler unit scans the instructions and modifies the compiled source codes such that in the modified codes, each instruction is modified together with a previous instruction and the modified codes are bound together as a linked chain to enforce the execution order. In some embodiments, when applying a function to the instructions, a reset instruction is injected to each multi-access address. During code execution, a device including a memory unit for storing the modified codes and a processor loads the modified codes, obtains extracted instructions from the modified codes by applying a reverse function, including forgoing applying the reverse function to the reset instruction before code execution.

### TECHNICAL FIELD

The present disclosure relates generally to computer security and, more specifically, to preventing code flow attacks in computer systems.

### BACKGROUND

Control flow integrity (CFI) refers to computer security techniques that prevent attacks redirecting the flow of program code execution (i.e., control or code flow attacks). Solutions based on code checkups typically verify running code hash values. Upon detecting unexpected values, a security violation exception is raised indicating code flow errors and/or attacks. Currently, many code flow detection techniques relying on code checkups require a significant amount of memory, e.g., inflating the code with new CFI specific instructions, and cannot identify code flow attacks immediately, e.g., not until the next CFI checkup. Such techniques cannot efficiently detect and protect against control flow attacks in real time.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIGS. 1A-1C are block diagrams of exemplary computing systems for providing control flow integrity (CFI), in accordance with some embodiments;

FIG. 2 is a diagram illustrating an exemplary extended compilation process in the exemplary computing system, in accordance with some embodiments;

FIGS. 3A and 3B are flowcharts illustrating an exemplary process of identifying multi-access addresses and modifying instructions at the multi-access addresses, in accordance with some embodiments;

FIG. 4 is a diagram illustrating extracting instructions from modified codes during execution in the exemplary computing system, in accordance with some embodiments;

FIGS. 5A and 5B are diagrams illustrating enhanced protection against code injection and code dump in the exemplary computing system, in accordance with some embodiments;

FIGS. 6A and 6B are flowcharts illustrating an extended compilation method for enhanced CFI, in accordance with some embodiments;

FIG. 7 is a flowchart illustrating a code extraction method during execution for enhanced CFI, in accordance with some embodiments;

FIG. 8 is a block diagram of a computing device for generating modified codes for enhanced CFI, in accordance with some embodiments; and

FIG. 9 is a block diagram of a computing device for executing modified codes for enhanced CFI, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overviews

Methods, devices, and systems described herein provide control flow integrity (CFI) at runtime with minimal storage overhead and low performance impact. In some embodiments, during extended compilation, an extended compiler unit processes compiled binary file(s) and builds modified codes so that each instruction is manipulated using the previous instruction, e.g., encrypting, applying XOR and/or any other form of light two-way manipulation function, etc. As a result, each instruction is manipulated together with the previous instruction to bind the instructions together as a linked chain, and the linked chain enforces the execution order of the instructions. At runtime, in the case of instruction(s) being injected, jumped, and/or glitched over, execution of such instruction(s) fails. Because such codes do not act as planned, an exception is triggered immediately or within a few instructions. The CFI techniques described herein thus improve the effectiveness and efficiency of detecting and protecting against code flow attacks.

In accordance with various embodiments, an extended compilation method is performed at a device that includes one or more memory units for storing one or more of instructions corresponding to compiled source codes and modified codes as well as an extended compiler unit. The extended compiler unit scans the instructions to identify a set of code addresses in the one or more memory units that is accessible from more than one address. The extended compiler unit then generates the modified codes from the instructions using a function, including injecting a reset instruction to each address in the set of code addresses. The extended compiler unit also stores the modified codes in the one or more memory units.

In accordance with various embodiments, a code execution method is performed at a target device (e.g., with a modified CPU) that includes a memory unit for storing modified codes and a processor (e.g., a modified CPU and/or a secure CPU). The processor loads the modified codes, where the modified codes are generated from instructions using a function, including by modifying instructions at a set of code addresses identified as being accessible from more than one address. The processor also obtains extracted instructions from the modified codes by applying a reverse function of the function to the modified codes, including forgoing applying the reverse function to the reset instruction at each address in the set of code addresses. The processor then executes the extracted instructions.

### EXAMPLE EMBODIMENTS

As described above, currently, many previously existing solutions require a significant amount of extra RAM and/or cannot identify control flow errors immediately. Methods, devices, and systems for control flow integrity (CFI) described herein in accordance with various embodiments modify running codes without using additional memory to store the modified code. Relative to previously existing solutions that detect attacks at the next CFI checkup, the methods, devices, and systems described herein detect code flow errors immediately while the attacks are occurring. Further, in some embodiments, the techniques described herein also protect against attacks such as code injection and code dump, thus improving the security of computer systems.

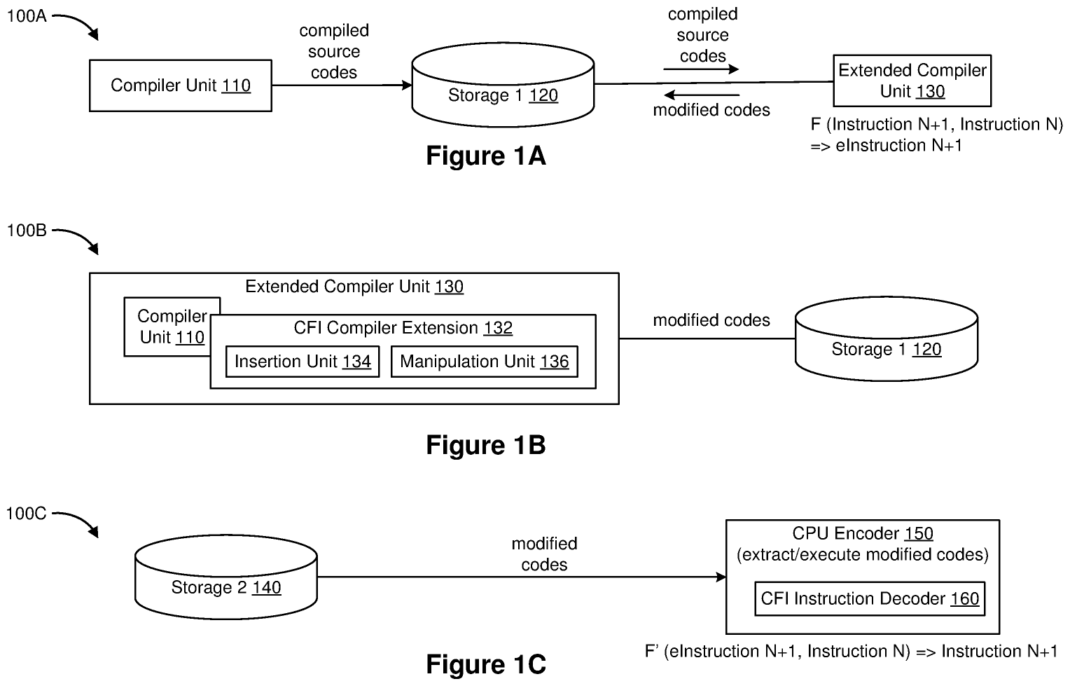

Reference is now made to FIGS. 1A-1C, which are block diagrams of exemplary extended compilation systems 100A and 100B and an execution environment 100C for providing enhanced CH in accordance with some embodiments. In some embodiments, the extended compilation system 100A, e.g., a computing device, includes a compiler unit 110, a first storage unit 120, and an extended compiler unit 130. In some embodiments, the compiler unit 110 compiles instructions that correspond to one or more application programs, generates compiled source codes, and stores the compiled source codes in the first storage unit 120. The compiled source codes are object codes in accordance with some embodiments, e.g., an intermediate or low-level language, which can then be executed by a processor, e.g., a CPU.

In some embodiments, the extended compiler unit 130 obtains the compiled source codes and generates modified codes. In some embodiments, to generate the modified codes, the extended compiler unit 130 identifies instructions corresponding to the compiled source codes and manipulates each instruction using the previous instruction, e.g., applying encryption, XOR, and/or any other form of light two-way manipulation function(s) F (Instruction N+1, Instruction N) to generate the modified code, e.g., encrypted instruction denoted as eInstruction N+1. As used herein, programs written in various programming languages are compiled into binary codes, which include a list of instructions. Also as used herein, an instruction is an intermediate or low-level command that a CPU can execute. Each instruction includes an opcode that corresponds to a command number. Some instructions also include an operand as the command parameter, e.g., jmp X, where the jmp command is the opcode and the address of X is the operand. When generating the modified codes, the opcode and optionally the operand of each instruction are manipulated using the opcode and optionally the operand of the previous instruction.

In some embodiments, the extended compiler unit 130 adds a key to the function when applying the function to generate the modified codes, e.g., F (Instruction N+1, Instruction N, key). The added key provides extra protection against code injection and code dump decryption. In particular, when code manipulation functions are well known or easy to break, using a key protects against an attacker injecting a complete block of code. Further, in some embodiments, for enhanced security, the key is different at different times and/or for different code modules. In some embodiments, once the extended compiler unit 130 generates the modified codes, the extended compiler unit 130 stores the modified codes in the first storage unit 120. In some embodiments, the first storage unit 120 includes a non-transitory computer-readable storage media (e.g., a non-volatile memory) and/or volatile memory.

In some embodiments, instead of modifying the codes and changing addresses post compilation, e.g., inserting or injecting instructions, the extended compiler unit 130 is integrated with the compiler unit 110 as shown in FIG. 1B. In the extended compilation system 100B, a CFI compiler extension unit 132 is integrated with the compiler unit 110 such that the extended compilation operations are performed as part of the compilation process. In such embodiments, the extended compiler unit 130 compiles the source code as well as performs the code manipulations and injects instructions to generate the modified codes. In some embodiments, the CFI compiler extension unit 132 further includes an insertion unit 134 for instruction insertion and a manipulation unit 136 for manipulating the codes, e.g., applying a function to the instructions as described above with reference to FIG. 1A.

Once the modified codes are generated, the modified codes are also stored in a second storage unit 140 in FIG. 1C in accordance with some embodiments. The first storage unit 120 in FIGS. 1A and 1B and the second storage unit 140 in FIG. 1C can be on the same device or different devices in accordance with various embodiments. For example, an application is being developed in a developing environment, e.g., on a computing device used by the developers with the compiler unit 110, the first storage unit 120, and the extended compiler unit 130 in FIGS. 1A and 1B. The result of the extended compilation process can be a package of the modified codes, e.g., as a binary file and/or an executable file, that is loadable to a target device for deployment and execution, e.g., loaded to the second storage unit 140 on a client device, a user equipment, a portable computing device, and/or any other different computing device. In some embodiments, the modified codes are downloaded to the second storage unit 140 in electronic form, e.g., over a network, and/or stored on tangible storage media, such as optical, magnetic, or electronic memory media.

During execution, the secure processor (e.g., one or more special CPUs) hosting a CPU encoder unit 150 (e.g., a processing unit for processing multimedia content) obtains the modified codes from the second storage unit 140 and a CFI instruction decoder 160 in the CPU encoder unit 150 calculates each clear instruction as a function of the manipulated instruction and the previous clear instruction, e.g., clear instruction=F (modified code, clear previous instruction) or applying a reverse function F′ (eInstruction N+1, Instruction N) to generate the clear instruction Instruction N+1 as shown in FIG. 1C. The CPU encoder unit 150 then executes the extracted clear instructions.

For example, the compiled source codes generated by the compiler unit 110 (FIGS. 1A and 1B) correspond to the following instructions:
INS0
INS1
INS2

During extended compilation, the extended compiler unit 130 (FIGS. 1A and 1B) generates the following modified codes:
eINS0
eINS1
eINS2

The above modified codes are stored in the first storage unit 120 (FIGS. 1A and 1B) in some embodiments. Moreover, the above modified codes are stored in the second storage unit 140 (FIG. 1C) for retrieval by the CPU encoder unit 150 (FIG. 1C) during execution. The CH instruction decoder 160 (FIG. 1C) obtains the modified codes and extracts clear instructions as follows:
eINS0->extract instruction (INS0)=initial value XOR INS0
eINS1->extract instruction (INS1)=INS0 XOR INS1
eINS2->extract instruction (INS2)=INS1 XOR INS2

In the example above, the initial value used for extracting the clear instruction INS0 is a pre-defined first instruction value, e.g., CFI-first-value in accordance with some embodiments.

In some embodiments, the secure processor includes dedicated hardware logic circuits, e.g., in the form of an application-specific integrated circuit (ASIC), field programmable gate array (FPGA), and/or custom integrated circuit. In some embodiments, the secure processor is a programmable processor, such as a microprocessor or digital signal processor (DSP), under the control of suitable codes, e.g., the codes in the second storage unit 140. As such, the secure processor can be one or more special purpose, dedicated processors operative to perform the method for ensuring CFI described herein.

Similar to the storage units, the CPU encoder unit 150 in FIG. 1C can be distinct and external to the compiler unit 110 and/or the extended compiler unit 130 in FIGS. 1A and 1B in accordance with some embodiments. Alternatively, the CPU encoder unit 150 in FIG. 1C can be on the same computing device as the compiler unit 110 and/or the extended compiler unit 130 in FIGS. 1A and 1B in accordance with some embodiments. As such, in various embodiments, the CPU encoder unit 150, the compiler unit 110, and/or the extended compiler unit 130 can be on the same processor and/or distributed on different processors and/or devices. For example, the compiler unit 110, the first storage unit 120, and the extended compiler unit 130 can be on a first computing device; and the second storage unit 140, the CPU encoder unit 150, and the CFI instruction decoder 160 can be on a second computing device, where the first computing device and the second computing device can be the same or different computing devices.

As shown in FIGS. 1A-1C, using the CFI methods, devices, and systems described herein, the running codes are modified so that each instruction is manipulated using the previous instruction. The advantage is to provide a CFI at runtime with low space overhead and low performance impact. As will be described in further detail below, in the case of instruction(s) being injected, jumped, or glitched over, the instruction execution would fail. In some embodiments, the failed execution triggers an illegal instruction exception immediately or in a few instructions. In some embodiments, instead of (or in addition to) the illegal instruction exception, an exception is generated by the CPU encoder unit 150 when the CPU encoder unit 150 performs a validity check at the time of executing the extracted clear instruction and determines that the extracted clear instruction is invalid.

For example, in the case of the secure processor hosting the CPU encoder unit 150 being a 32-bit processor, using checksum (CS) as the validity check, each word (i.e., 32-bit) is extended by 2 bits to 34-bit, where the last 2 bits are data integrity CS. In some embodiments, the CS is calculated during compilation and/or before applying the manipulation function as shown in FIG. 1A, where the CS is calculated as a function of the clear 32-bit instructions, e.g., CS=Bit 0-1 XOR Bit 2-3 XOR . . . XOR Bit 30-31. During the execution stage as shown in FIG. 1C, the CPU encoder unit 150 verifies CS after extracting the clear instructions but before the execution. In the case of CS being invalid, the CPU encoder unit 150 throws a CS exception indicating an error or attack. As such, using validity check methods such as checksum, the CPU encoder unit 150 can detect CFI attacks immediately.

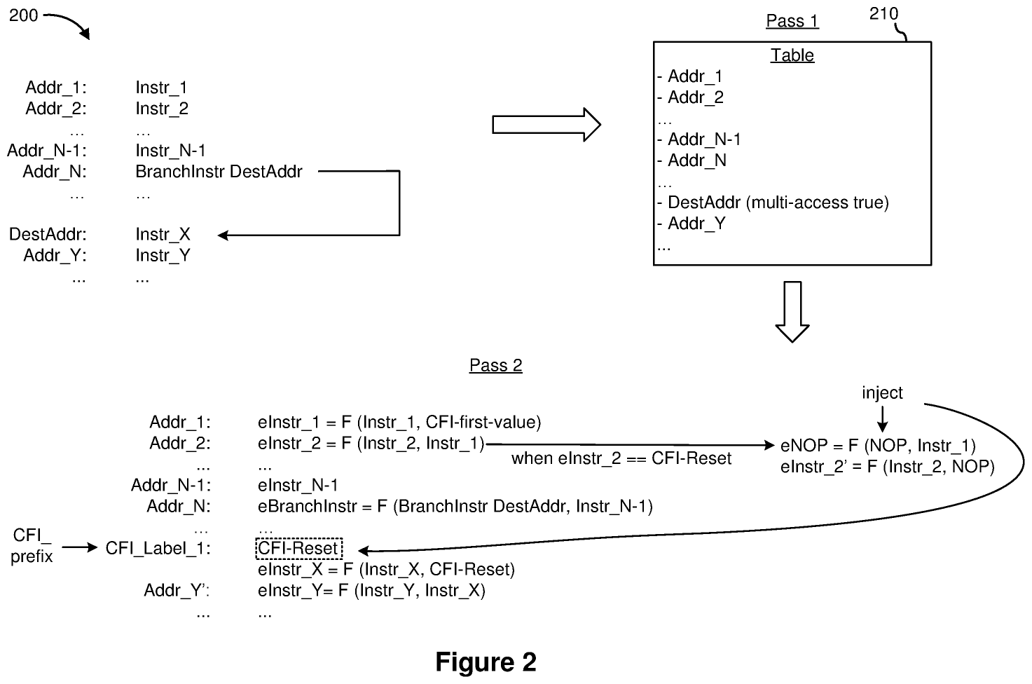

FIG. 2 is a diagram 200 illustrating an exemplary extended compilation process in accordance with some embodiments. In some embodiments, during a first pass of the extended compilation process, the extended compiler unit 130 (FIGS. 1A and 1B) processes intermediate compiler files that have compiled source codes, e.g., the compiled source codes stored in the first storage unit 120 (FIGS. 1A and 1B). Further, in some embodiments, the extended compiler unit scans instructions corresponding to the compiled source codes in the intermediate compiler files in order to identify code address(s) accessible from more than one address. For example, in FIG. 2, by scanning instructions corresponding to the compiled source codes, the extended compiler unit identifies instructions and the addresses, e.g., identifying Instr_1 at Addr_1, Instr_2 at Addr_2, . . . , Instr_N−1 at Addr_N−1, BranchInstr at Addr_N, . . . , Instr_X at DestAddr, Instr_Y at Addr_Y, etc. Further, by scanning the instructions, the extended compiler unit identifies addresses that are accessible from more than one address, e.g., DestAddr accessible from Addr_N through a branching instruction BranchInstr.

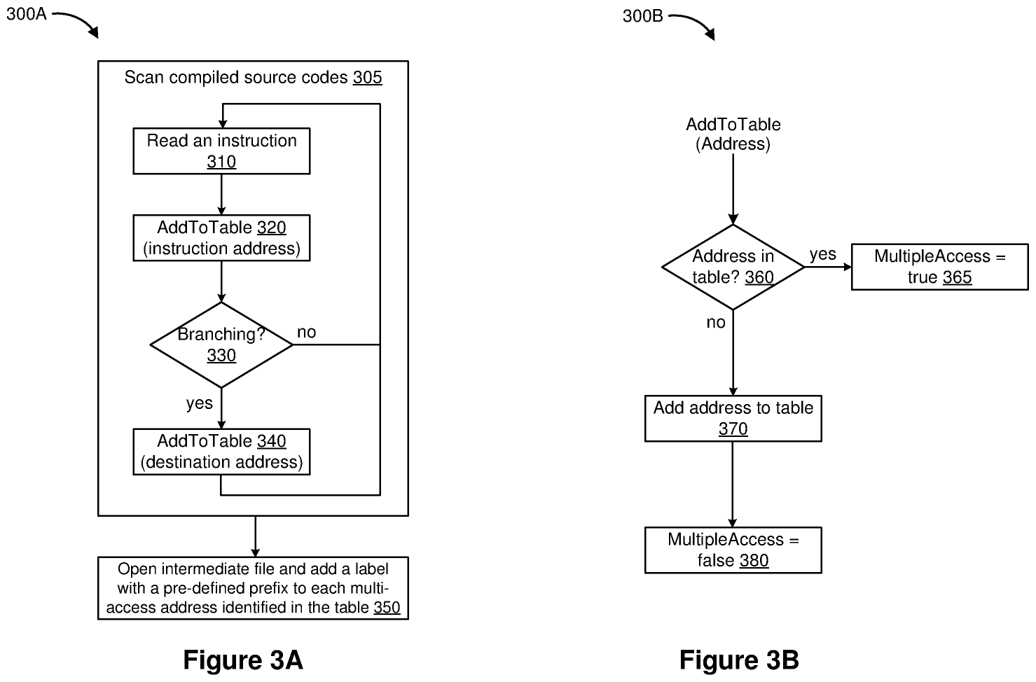

Upon identifying the addresses, as shown in FIG. 2, during the first pass of the extended compilation process, the extended compiler unit constructs and maintains a table 210 for storing the addresses. FIGS. 3A and 3B are flow charts 300A and 300B illustrating an exemplary process of identifying multi-access addresses and modifying instructions at the multi-access addresses in accordance with some embodiments. In FIG. 3A, when the extended compiler unit 130 (FIGS. 1A and 1B) scans the compiled source codes in step 305, the extended compiler unit 130 performs steps 310-340 for each instruction identified in the compiled source codes in accordance with some embodiments. In step 310, the extended compiler unit reads an instruction and adds the instruction address to the table 210 (FIG. 2) in step 320. For example, in the example shown in FIG. 2, the extended compiler unit reads Instr_1 at Addr_1 and adds Addr_1 to the table 210.

Still referring to FIG. 3A, in step 330, the extended compiler unit determines whether the instruction is a branch instruction with a destination address and the destination address is not an address of a function in accordance with some embodiments. In some embodiments, in the case of the instruction being a branch instruction (“Yes”-branch from step 330), the extended compiler unit adds the destination address to the table in step 340 before returning to step 310 to process the next instruction. On the other hand, in some embodiments, in the case of the instruction not being a branch instruction (“No”-branch from step 330), the scanning process returns to step 310 to process the next instruction. Once the extended compiler unit scans the compiled source code, the extended compiler unit opens the intermediate file and adds a label with a pre-defined prefix to each address identified in the table being multi-access in step 350 in accordance with some embodiments.

In some embodiments, when adding an address to the table, as shown in FIG. 3B, the extended compiler unit determines whether the address already exists in the table in step 360. In the case of the address being in the table (“Yes”-branch from step 360), the extended compiler unit sets the multi-access indicator for the address to “true” in step 365. On the other hand, in the case of the address not being in the table (“No”-branch from step 360), the extended compiler unit adds the address to the table in step 370 and sets the multi-access indicator for the address to “false” in step 380 in accordance with some embodiments.

For example, in FIG. 2, when the extended compiler unit processes BranchInstr at Addr_N, DestAddr is added to the table 210 in step 340 (FIG. 3A) (e.g., in step 370, FIG. 3B) and the multi-access indicator for DestAddr is set to “false” in step 380. When the extended compiler unit processes Instr_X at DestAddr, because DestAddr is already in the table, indicating the address is accessible from more than one address, the multi-access indicator for DestAddr is set to “true” in step 365 (FIG. 3B). As a result of the first pass of the scanning, the table 210 shown in FIG. 210 is constructed, which includes addresses such as Add_1, Addr_2, . . . , Addr_N−1, Addr_N, . . . , DestAddr, Addr_Y, etc., and the multi-access indicator for DestAddr in the table 210 is set to “true”. Also as shown in FIG. 2, in some embodiments, according to the table 210, the extended compiler unit opens the intermediate file and adds a label with CFI_prefix as the predefined prefix to each address identified as being multi-access in the table 210. In some other embodiments, as described above with reference to FIG. 1B, instead of opening the intermediate file and changing the address label post compilation, the manipulation unit 136 of the CFI compiler extension 132 establishes the table 210, updates the address label according to the table 210, and/or manipulating the codes during compilation.

Still referring to FIG. 2, in some embodiments, during a second pass of the extended compilation process, the extended compiler unit generates the modified codes, e.g., eInstr_1, eInstr_2, . . . , eInstr_N−1, eBranchInstr, etc. As described above with reference to FIG. 1A, in some embodiments, each of the modified codes is calculated as a function of the clear instruction and the previous clear instruction. In some embodiments, in the case of the instruction being the first instruction, e.g., at a reset address or the first instruction after a code branch (e.g., jump, call, etc.), the extended compiler unit uses a predefined first instruction value as the previous clear instruction value. For example, in FIG. 2, the extended compiler unit calculates eInstr_1 using CFI-first-value as the predefined first instruction value, e.g., eInstr_1=F (Instr_1, CFI-first-value). In some embodiments, the extended compiler unit replaces the clear instructions corresponding to the compiled source codes with the modified codes in the intermediate file, e.g., replacing the compiled source codes stored in the first storage unit 120 (FIGS. 1A and 1B) with the modified codes. In some other embodiments, the extended compiler unit stores both the compiled source codes and the modified source codes in the first storage unit 120 (FIGS. 1A and 1B).

In some embodiments, to handle instructions at addresses with multi-access indicators set to “true” in the table 210, e.g., having the predefined prefix such as CFI_in the address label, the extended compiler unit injects a reset instruction to the codes, e.g., at each address indicated by the CFI_prefix label. For example, in FIG. 2, the extended compiler unit injects a CFI-Reset instruction to the address with CFI_prefix. In some embodiments, the CFI-Reset instruction has a fixed value and is not modified during the extended compilation process. In some embodiments, the predefined prefix such as CFI_is added, e.g., manually, to certain addresses so that the extended compiler adds at each of such addresses a CFI-Reset instruction. The manual address labeling is applied for certain multi-access addresses, e.g., addresses associated with JumpTable or dynamic program counter (PC) changes that may not be recognizable following the processes illustrated in FIGS. 3A and 3B.

Upon injecting the CFI-Reset instruction, e.g., by the insertion unit 134 (FIG. 1B), the extended compiler unit modifies Instr_X that was at the address labeled with CFI_prefix by applying a function to Instr_X and CFI-Reset, e.g., eInstr_X=F (Instr_X, CFI-Reset). Because of the address change due to the code injection, Instr_Y at Addr_Y before the extended compilation process is modified by applying the function, e.g., eInstr_Y=F (Instr_Y, Instr_X) and the modified code eInstr_Y is at Addr_Y′.

As described above with reference to FIG. 1A, the function f can be any type of symmetric encryption function, including XOR or any 2-way manipulation function. In some embodiments, in the case of the modified codes having the same value as CFI-Reset, e.g., eInstr_2 calculated as F (Instr_2, Instr_1) having the same value as CFI-Reset, the extended compiler unit injects an NOP or any other non-effective instruction before such modified codes so that the recalculated modified codes would have a different value, e.g., injecting eNOP=F (NOP, Instr_1) by the insertion unit 134 (FIG. 1B) at Addr_2 followed by eInstr_2′=F (Instr_2, NOP) at the next address.

As shown in FIGS. 1A-1C, 2, and 3A-3B, by modifying each instruction, e.g., linking each instruction with the previous instruction, the modified codes are bound together as a linked chain. In particular, when the instruction is at a reset address or the first instruction after a code branch as shown in FIG. 2, the linked chain enforces the execution order. Moreover, when executing the modified codes, in the case of any part of the linked chain being broken into, e.g., code flow attacks with injected, jumped, or glitched over codes, the execution of the modified codes stops immediately or within a few instructions, e.g., due to an illegal instruction exception or failing the validity check. As such, relative to previous code flow detection techniques that rely on code checkups at next CFI checkup, the techniques described herein are more efficient and effective against code flow attacks.

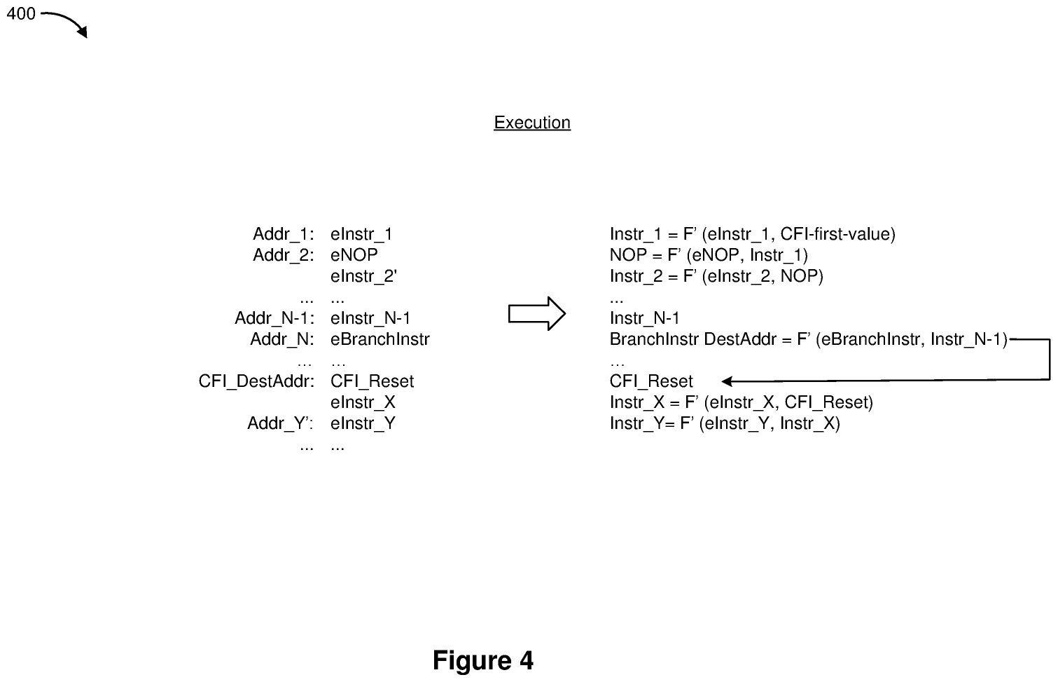

FIG. 4 is a diagram 400 illustrating extracting instructions from the modified codes during execution in accordance with some embodiments. As described above with reference to FIG. 1C, during execution, the CFI instruction decoder 160 reads the modified codes from the second storage unit 140 and extracts clear instructions from the modified codes for execution by the CPU encoder 150, e.g., decoding and/or decrypting the modified codes. Also as described above with reference to FIG. 1C, the CFI instruction decoder 160 applies a reverse function on the modified codes, Instruction=F′ (eInstruction N+1, Instruction N). In some embodiments, in the case of the instruction being the first instruction, e.g., after reset or after code branch such as jump, call, return, etc., the CFI instruction decoder uses the predefined first instruction value as the previous clear instruction. For example, in FIG. 4, Instr_1 is the first instruction and is calculated by applying F′ to eInstr_1 and CFI-first-value. As such, during execution, after call, return, and/or jump instructions, the CPU encoder 150 resets the CFI mechanism, e.g., extracting the next instruction using CFI-first-value without injecting CFI-Reset instruction. Accordingly, the CFI mechanism described herein has minimal impact on code size.

During execution, the CPU encoder unit 150 (FIG. 1C) obtains the clear instructions extracted by the CFI instruction decoder 160 and execute the extracted clear instructions, e.g., executing Instr_1, NOP, Instr_2, . . . Instr_N−1, etc. In some embodiments, in the case of the modified codes corresponding to the reset instruction, the CPU encoder does not execute such instructions and continues to the next instruction. For example, upon executing BranchInstr, the CPU encoder skips the execution of CFI_Reset and continues to execute Instr_X after branching. As such, Instr_X is calculated based on the assumption that the value of the previous instruction is a predefined value such as CFI-first-value.

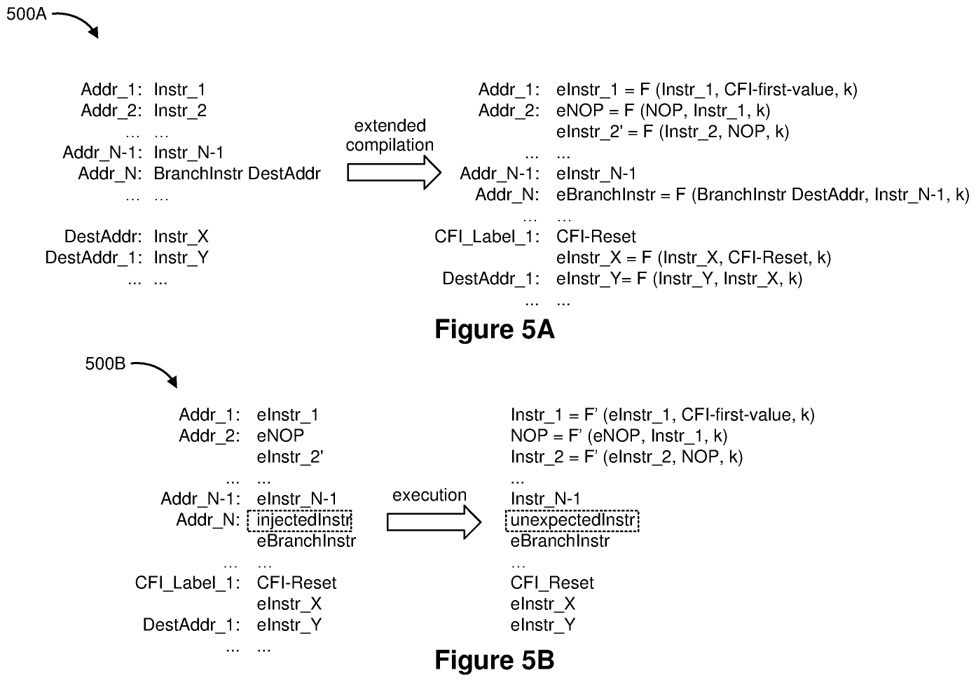

FIGS. 5A and 5B are diagrams 500A and 500B illustrating using the extended compilation and code extraction methods described herein for protection against code dump (e.g., for understanding the codes) and code injection in accordance with some embodiments. In some embodiments, a dynamic key is added to the modification function as a parameter. For example, in FIG. 5A, using the extended compilation process as described above with reference to FIGS. 1A-1B, 2, and 3A-3B, the extended compiler unit modifies the instructions corresponding to the compiled source codes by applying the modification function F. Further, in some embodiments, a key (denoted as k) is used as part of the calculation, e.g., eInstr_1=F (Instr_1, CFI-first-value, k). Using the key enhances security for the modification function such as XOR and/or light symmetric encryption function. Further, in some embodiments, the dynamic key changes, e.g., changing periodically, changing to different keys for different code modules, etc. The key changes further enhance security and protect against code dump and/or code injection.

FIG. 5B illustrates that when code injection occurs, during execution, the CPU encoder unit 150 (FIG. 1C) and/or the CFI instruction decoder 160 (FIG. 1C) can detect a code flow error immediately. For example, during execution, the CFI instruction decoder applies the reverse function F′ to the modified codes and extracts clear instructions for execution, e.g., Instr_1=F′ (eInstr_1, CFI-first-value, k), NOP=F′ (eNOP, Instr_1, k), Instr_2=F′ (eInstr_2, NOP, k), etc. However, once an instruction is injected, e.g., injecting injectedInstr at Addr_N, when applying the reverse function F′ to the injectedInstr, an unexpected instruction is extracted, which causes a code flow error immediately, e.g., by detecting an illegal instruction exception or a checksum error. In some embodiments, upon detecting the code flow error, the CFI instruction decoder ceases to extract clear instructions from the modified code and/or the CPU encoder ceases to execute the codes to protect against code injection.

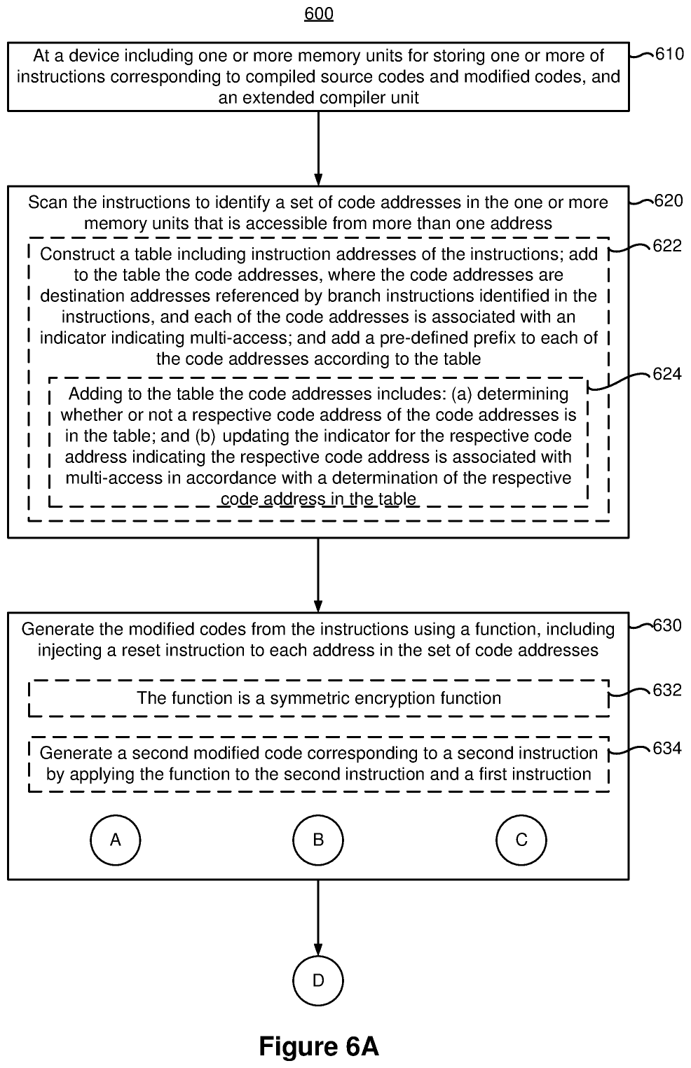

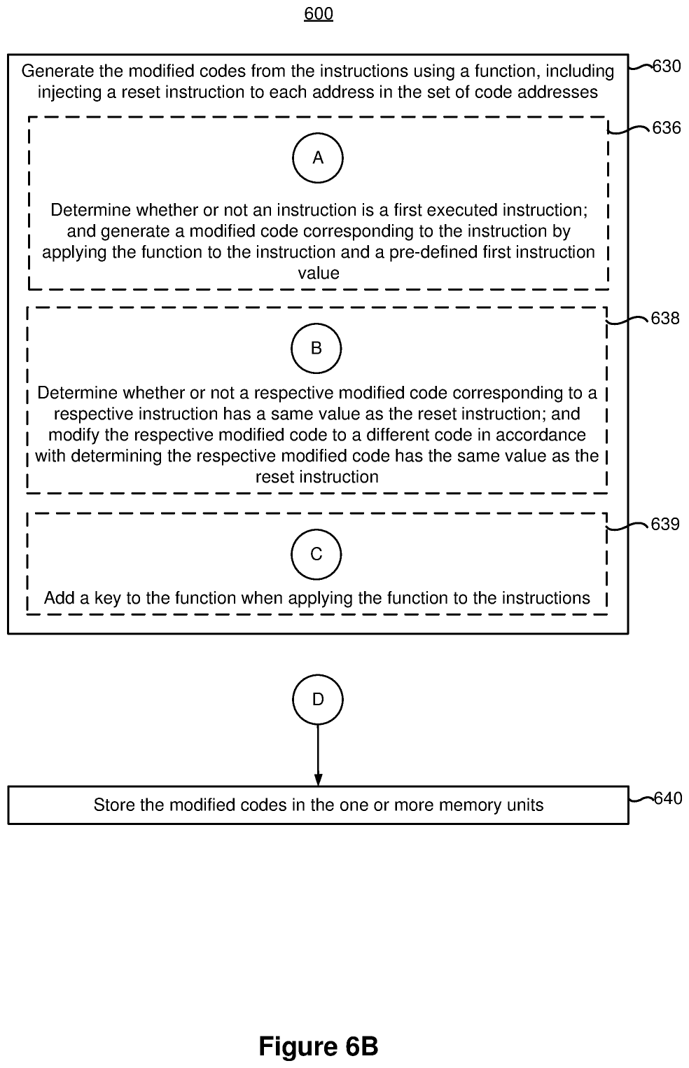

FIGS. 6A and 6B are flowcharts illustrating an extended compilation method 600 for enhanced CFI in accordance with some embodiments. In some embodiments, as represented by block 610, the method 600 is performed at a device, e.g., the computing device hosting the compiler unit 110, the first storage unit 120, and the extended compiler unit 130 in FIGS. 1A and 1B. In some embodiments, the device includes one or more memory units (e.g., one or more memory units of the first storage unit 120, FIG. 1A) for storing one or more of instructions corresponding to compiled source codes and modified codes, and an extended compiler unit (e.g., the extended compiler unit 130, FIGS. 1A and 1B). In some embodiments, the method 600 is performed by various modules within the extended compiler unit 130 (FIGS. 1A and 1B).

The method 600 begins with the extended compiler unit scanning the instructions to identify a set of code addresses in the one or more memory units that is accessible from more than one address as represented by block 620. In some embodiments, as represented by block 622, scanning the instructions to identify the code addresses in the one or more memory units that is accessible from more than one address includes: (a) constructing a table including instruction addresses of the instructions; (b) adding to the table the code addresses, wherein the code addresses are destination addresses referenced by branch instructions identified in the instructions, and each of the code addresses is associated with an indicator indicating multi-access; and (c) adding a pre-defined prefix to each of the code addresses according to the table. In such embodiments, as represented by block 624, adding to the table the code addresses includes: (a) determining whether or not a respective code address of the code addresses is in the table; and (b) updating the indicator for the respective code address indicating the respective code address is associated with multi-access in accordance with a determination of the respective code address in the table.

For example, as shown in FIG. 1A, the extended compiler unit 130 obtains the compiled source codes from the one or more memory units of the first storage unit 120. Further, as shown in FIG. 2 and using the process illustrated in FIGS. 3A and 3B, the extended compiler unit scans the instructions corresponding to the compiled source codes to identify code addresses, e.g., DestAddr referenced in BranchInstr, that are accessible from more than one address, constructs the table 210 to store such code addresses, and sets the multi-access indicator to “true” in the table 210 for such code addresses. Additionally, as shown in FIG. 2, the extended compiler unit adds a label with the pre-defined prefix such as CFI_ to code addresses indicated as multi-access in the table 210. Also as shown in FIG. 2, the addresses with the multi-access indicator set to “true” are accessible from more than one address, e.g., DestAddr that is accessible from executing linearly and from BranchInstr, are not function start addresses, and have not previously been marked with the pre-defined prefix CFI.

As represented by block 630, the method 600 continues with the extended compiler unit generating (e.g., by the extended compiler unit 130 in FIG. 1A and/or the manipulation unit 136 in FIG. 1B) the modified codes from the instructions using a function, including injecting (e.g., by the extended compiler unit 130 post compilation in FIG. 1A and/or the insertion unit 134 in FIG. 1B during compilation) a reset instruction to each address in the set of code addresses. In some embodiments, as represented by block 632, the function is a symmetric encryption function. For example, the function shown in FIGS. 1A, 2, and 5 can be any type of symmetric encryption function that is light for performance consideration. In another example, the function can be XOR. Since the operation of XOR is light, applying XOR has minimal performance impact. Further, since the modified codes generated from applying XOR to the clear codes do not inflate the size of the codes, storing the modified codes does not require additional memory when the modified codes replace the clear compiled source codes, thus keeping the storage overhead low. In some embodiments, as represented by block 634, generating the modified codes from the instructions using the function includes generating a second modified code corresponding to a second instruction by applying the function to the second instruction and a first instruction, e.g., eInstruction N+1=F (Instruction N+1, Instruction N) as shown in FIG. 1A.

Turning to FIG. 6B, in some embodiments, as represented by block 636, generating the modified codes from the instructions using the function includes: determining whether or not an instruction is a first executed instruction; and generating a modified code corresponding to the instruction by applying the function to the instruction and a pre-defined first instruction value. In some embodiments, as represented by block 638, generating the modified codes from the instructions using the function includes: determining whether or not a respective modified code corresponding to a respective instruction has a same value as the reset instruction; and modifying the respective modified code to a different code in accordance with determining the respective modified code has the same value as the reset instruction. In some embodiments, as represented by block 639, generating the modified codes from the instructions using the function includes adding a key to the function when applying the function to the instructions.

For example, in FIG. 2, in the case of the instruction being the first instruction such as Instr_1, the extended compiler unit generates the modified code corresponding to eInstru_1 by applying the function to Instr_1 and the pre-defined first instruction value CFI-first-value, e.g., eInstr_1=F (Instr_1, CFI-first-value). Also as shown in FIG. 2, upon determining that eInstr_2 has the same value as the reset instruction CFI-Reset, the extended compiler unit adds NOP before the instruction and modifies eInstr_2 to a different value eInstr_2′, e.g., eNOP=F (NOP, Instr_1) and eInstr_2′=F (Instr_2, NOP). In another example, as shown in FIG. 5A, a dynamic key can be added to the manipulation function for enhanced protection against code injection and code dump decryption, e.g., eInstr_1=F (Instr_1, CFI-first-value, k), eNOP=F (NOP, Instr_1, k), eInstr_2′=F (Instr_2, NOP, k), eBranchInstr=F (BranchInstr DestAddr, Instr_N−1, k), or eInstr_X=F (Instr_X, CFI-Reset, k).

Still referring to FIG. 6B, as represented by block 640, the method 600 continues with the extended compiler unit storing the modified codes in the one or more memory units, e.g., storing the modified codes in the first storage unit 120 as shown in FIGS. 1A and 1B.

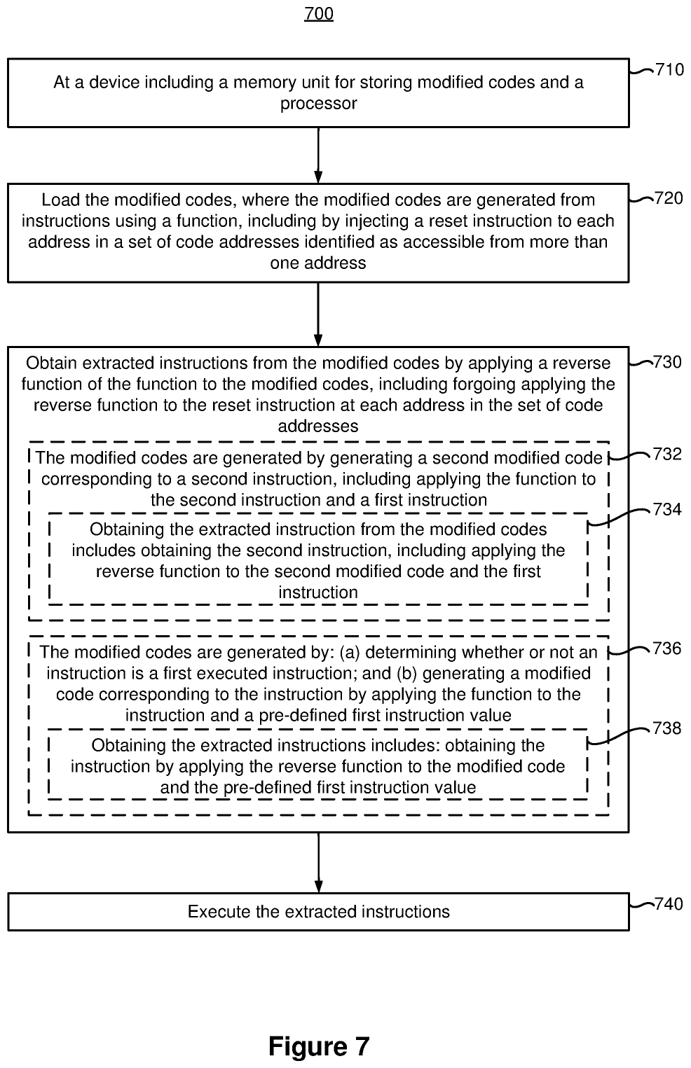

FIG. 7 is a flowchart illustrating a code extraction method 700 during execution in accordance with some embodiments. In some embodiments, as represented by block 710, the method 700 is performed at a device that includes a memory unit for storing modified codes and a processor, e.g., the computing device hosting the second storage unit 140 and the CPU encoder unit 150 in FIG. 1C. In some embodiments, the method 700 is performed by various modules of the CPU encoder unit 150 (FIG. 1C), e.g., including the CFI instruction decoder 160 (FIG. 1C).

The method 700 begins with the CFI instruction decoder loading the modified codes, wherein the modified codes are generated from instructions using a function, including injecting a reset instruction into each address in a set of code addresses identified as accessible from more than one address, as represented by block 720. For example, in FIG. 1C, the CFI instruction decoder 160 loads the modified codes from the second storage unit 140, where the modified codes are generated by the extended compiler unit 130 using a function as shown in FIG. 1A. Further, as described above with reference to FIG. 2, when modifying the compiled source codes corresponding to the instructions, the extended compiler unit injects a reset instruction such as CFI-Reset to addresses (e.g., CFI_Lable_1) that have been identified as accessible from more than one address, e.g., as indicated by the multi-access indicator in the table 210 and/or as indicated by the address label with the CFI_prefix.

The method 700 continues, as represented by block 730, with the CFI instruction decoder obtaining extracted instructions from the modified codes by applying a reverse function of the function to the modified codes, including forgoing applying the reverse function to the reset instruction at each address in the set of code addresses. For example, in FIG. 1C, the CFI instruction decoder applies the reverse function F′ to extract clear instructions from the modified instructions, e.g., instruction N+1=F′ (eInstruction N+1, Instruction N). Further as shown in FIG. 4, during the execution, the CFI instruction decoder assumes that the previous clear instruction value for CFI-Reset is CFI-first-value without applying the reverse function to CFI-Reset instruction and continues to applying the reverse function F′ to eInstr_X, e.g., Instr_X=F′ (eInstr_X, CFI-Reset).

In some embodiments, as represented by block 732, the modified codes are generated by generating a second modified code corresponding to a second instruction, including applying the function to the second instruction and a first instruction. In such embodiments, as represented by block 734, obtaining the extracted instruction from the modified codes includes obtaining the second instruction, including applying the reverse function to the second modified code and the first instruction. For example, during the extended compilation, as shown in FIG. 1A, the post compiler obtains the modified codes by applying the function F to the compiled source codes, e.g., eInstruction N+1=F (Instruction N+1, Instruction N). During the execution, as shown in FIG. 1C, the CFI instruction decoder 160 extracts the clear instructions for execution by applying F′, which is the reverse function of F, to the modified codes, e.g., Instruction N+1=F′ (eInstruction N+1, Instruction N) as shown in FIG. 1C.

In some embodiments, as represented by block 736, the modified codes are generated by: (a) determining whether or not an instruction is a first executed instruction; and (b) generating a modified code corresponding to the instruction by applying the function to the instruction and a pre-defined first instruction value. Further, as represented by block 738, in such embodiments, obtaining the extracted instructions includes obtaining the instruction by applying the reverse function to the modified code and the pre-defined first instruction value. For example, in FIG. 2, the extended compiler unit determines whether or not Instr_1 is a first executed instruction after reset or after code branch such as jump, call, return, etc. Also as shown in FIG. 2, the extended compiler unit generates the modified code eInstr_1 by applying the function F to Instr_1 and CFI-first-value, e.g., eInstr_1=F (Instr_1, CFI-first-value). In other words, in the case of first instruction, the extended compiler unit assumes previous-clear-instruction value being a predefined value such as CFI-first-value. During execution, as shown in FIG. 4, the CFI instruction decoder extracts the clear instruction Instr_1 by applying the reverse function F′ to the modified code eInstr_1 and CFI-first-value.

The method 700 continues with the CPU encoder unit 150 (FIG. 1C) executing the extracted instructions from the CFI instruction decoder 160 (FIG. 1C), as represented by block 740.

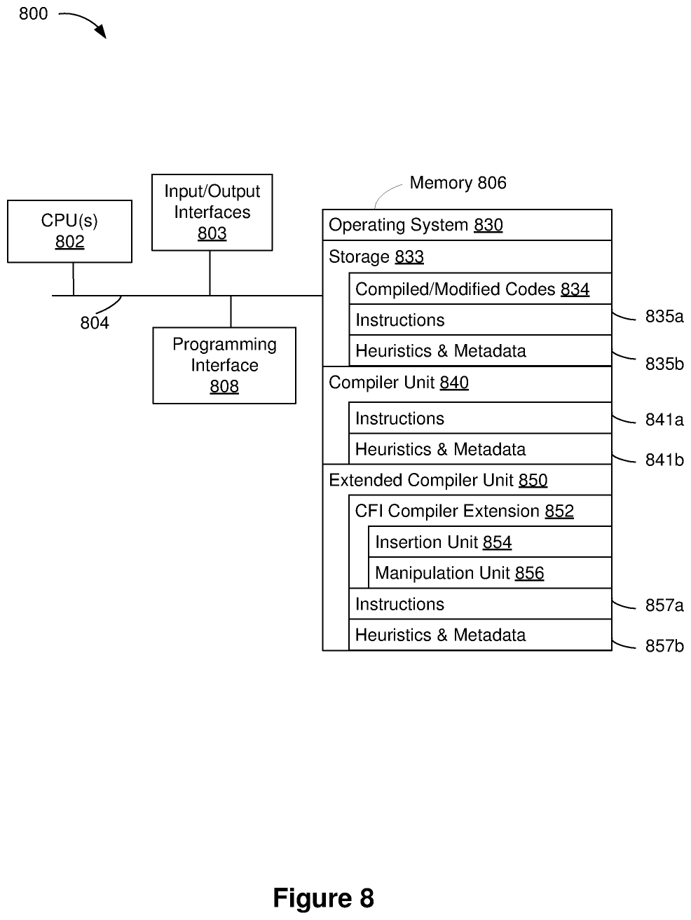

FIG. 8 is a block diagram of a computing device 800 for extended compilation in accordance with some embodiments. In some embodiments, the computing device 800 performs one or more functions of a device hosting the compiler unit 110, the first storage unit 120, and/or the extended compiler unit 130 in FIGS. 1A and 1B and performs one or more of the functionalities described above with respect to the compiler unit 110, the first storage unit 120, and/or the extended compiler unit 130. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 800 includes one or more processing units (CPUs) 802 (e.g., processors), one or more input/output interfaces 803 (e.g., input devices, sensors, a network interface, a display, etc.), a memory 806, a programming interface 808, and one or more communication buses 804 for interconnecting these and various other components.

In some embodiments, the communication buses 804 include circuitry that interconnects and controls communications between system components. The memory 806 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830, a storage module 833, a compiler unit 840, and an extended compiler unit 850. In some embodiments, one or more instructions are included in a combination of logic and non-transitory memory. The operating system 830 includes procedures for handling various basic system services and for performing hardware dependent tasks.

In some embodiments, the storage module 833, e.g., the first storage unit 120 in FIGS. 1A and 1B, stores compiled source codes and/or modified codes 834. To that end, the storage module 833 includes a set of instructions 835a and heuristics and metadata 835b.

In some embodiments, the compiler unit 840 (e.g., the compiler unit 110 in FIGS. 1A and 1B) is configured to compile source codes and generates compiled source codes in binary code files such as hex, elf, and/or exe files. To that end, the compiler unit 840 includes a set of instructions 841a and heuristics and metadata 841b.

In some embodiments, the extended compiler unit 850 (e.g., the extended compiler unit 130 in FIGS. 1A and 1B) is configured to scan instructions corresponding to the compiled source codes and generates modified codes from the instructions using a function to bound the modified codes together as a linked chain. In some embodiments, the extended compiler unit 850 further includes a CFI compiler extension 852 that is coupled to the compiler unit 840, e.g., the CFI compiler extension 132 in FIG. 1B, and generates the modified codes while compiler unit 110 compiling the source codes. In some embodiments, the CFI compiler extension 852 further includes an insertion unit 854 (e.g., the insertion unit 134, FIG. 1B) for injecting codes at certain addresses as described with reference to FIG. 2 and a manipulation unit 856 (e.g., the manipulation unit 136, FIG. 1B) for applying a function to generate the modified codes. To that end, the extended compiler unit 850 includes a set of instructions 857a and heuristics and metadata 857b.

Although the storage module 833, the compiler unit 840, and the extended compiler unit 850 are illustrated as residing on a single computing device 800, it should be understood that in other embodiments, any combination of the storage module 833, the compiler unit 840, and the extended compiler unit 850. For example, in some embodiments, each of the storage module 833, the compiler unit 840, and the extended compiler unit 850 resides on a separate computing device.

Moreover, FIG. 8 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

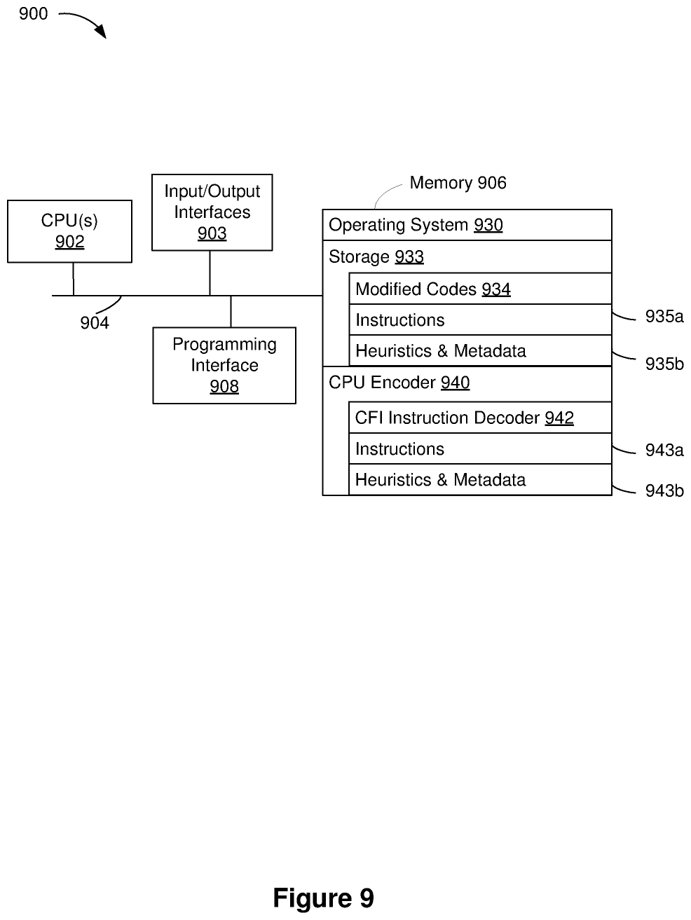

FIG. 9 is a block diagram of a computing device 900 for extracting clear codes from modified codes for execution in accordance with some embodiments. In some embodiments, the computing device 900 performs one or more functions of a device hosting the second storage unit 140 and the CPU encoder 150 in FIG. 1C and performs one or more of the functionalities described above with respect to the second storage unit 140 and the CPU encoder 150. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 900 includes one or more processing units (CPUs) 902 (e.g., processors), one or more input/output interfaces 903 (e.g., input devices, sensors, a network interface, a display, etc.), a memory 906, a programming interface 908, and one or more communication buses 904 for interconnecting these and various other components.

In some embodiments, the communication buses 904 include circuitry that interconnects and controls communications between system components. The memory 906 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 906 optionally includes one or more storage devices remotely located from the CPU(s) 902. The memory 906 comprises a non-transitory computer readable storage medium. Moreover, in some embodiments, the memory 906 or the non-transitory computer readable storage medium of the memory 906 stores the following programs, modules and data structures, or a subset thereof including an optional operating system 930, a storage module 933, a compiler unit 940, and an extended compiler unit 950. In some embodiments, one or more instructions are included in a combination of logic and non-transitory memory. The operating system 930 includes procedures for handling various basic system services and for performing hardware dependent tasks.

In some embodiments, the storage module 933, e.g., the second storage unit 140 in FIG. 1C, stores modified codes 934. To that end, the storage module 933 includes a set of instructions 935a and heuristics and metadata 935b.

In some embodiments, the CPU encoder 940 (e.g., the CPU encoder 150 in FIG. 1C) is configured to extract and/or execute modified codes. In some embodiments, the CPU encoder 940 includes CFI instruction decoder 942, e.g., the CFI instruction decoder 160 in FIG. 1C, for decoding and/or extracting clear instructions from the modified codes so that the CPU encoder 940 can execute the clear instructions. To that end, the CPU encoder 940 includes a set of instructions 943a and heuristics and metadata 943b.

Although the storage module 933 and the CPU encoder 940 are illustrated as residing on a single computing device 900, it should be understood that in other embodiments, any combination of the storage module 933 and the CPU encoder 940. For example, in some embodiments, each of the storage module 933 and the CPU encoder 940 resides on a separate computing device.

Moreover, FIG. 9 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 9 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a device including one or more memory units for storing one or more of instructions corresponding to compiled source codes and modified codes, and an extended compiler unit:
scanning the instructions to identify a set of code addresses in the one or more memory units that is accessible from more than one address;
generating the modified codes from the instructions using a function, including injecting a reset instruction to each address in the set of code addresses; and
storing the modified codes in the one or more memory units.

2. The method of claim 1, wherein scanning the instructions to identify the code addresses in the one or more memory units that is accessible from more than one address includes:
constructing a table including instruction addresses of the instructions;
adding to the table the code addresses, wherein the code addresses are destination addresses referenced by branch instructions identified in the instructions, and each of the code addresses is associated with an indicator indicating multi-access; and
adding a pre-defined prefix to each of the code addresses according to the table.

3. The method of claim 2, wherein adding to the table the code addresses includes:
determining whether or not a respective code address of the code addresses is in the table; and
updating the indicator for the respective code address indicating the respective code address is associated with multi-access in accordance with a determination of the respective code address in the table.

4. The method of claim 1, wherein the function is a symmetric encryption function.

5. The method of claim 1, wherein generating the modified codes from the instructions using the function includes:
generating a second modified code corresponding to a second instruction by applying the function to the second instruction and a first instruction.

6. The method of claim 1, wherein generating the modified codes from the instructions using the function includes:
determining whether or not an instruction is a first executed instruction; and
generating a modified code corresponding to the instruction by applying the function to the instruction and a pre-defined first instruction value.

7. The method of claim 1, wherein generating the modified codes from the instructions using the function includes:
determining whether or not a respective modified code corresponding to a respective instruction has a same value as the reset instruction; and
modifying the respective modified code to a different code in accordance with determining the respective modified code has the same value as the reset instruction.

8. The method of claim 1, wherein generating the modified codes from the instructions using the function includes:
adding a key to the function when applying the function to the instructions.

9. A method comprising:
at a device including a memory unit for storing modified codes and a processor:
loading the modified codes, wherein the modified codes are generated from instructions using a function, including by injecting a reset instruction to each address in a set of code addresses identified as accessible from more than one address;
obtaining extracted instructions from the modified codes by applying a reverse function of the function to the modified codes, including forgoing applying the reverse function to the reset instruction at each address in the set of code addresses; and
executing the extracted instructions.

10. The method of claim 9, wherein the modified codes are generated by generating a second modified code corresponding to a second instruction, including applying the function to the second instruction and a first instruction.

11. The method of claim 10, wherein obtaining the extracted instruction from the modified codes includes obtaining the second instruction, including applying the reverse function to the second modified code and the first instruction.

12. The method of claim 9, wherein the modified codes are generated by:
determining whether or not an instruction is a first executed instruction; and
generating a modified code corresponding to the instruction by applying the function to the instruction and a pre-defined first instruction value.

13. The method of claim 12, wherein obtaining the extracted instructions includes:
obtaining the instruction by applying the reverse function to the modified code and the pre-defined first instruction value.

14. The method of claim 9, further comprising:
performing a validity check when extracting a respective extracted instruction; and
generating an exception upon determining the respective extracted instruction is invalid.

15. A system comprising:
a first device including an extended compiler unit, one or more memory units for storing one or more of instructions corresponding to compiled source codes and modified codes, and one or more first programs, stored in the one or more memory units, which, when executed by the extended compiler unit, cause the first device to:
scan the instructions to identify a set of code addresses in the one or more memory units that is accessible from more than one address;
generate the modified codes from the instructions using a function, including injecting a reset instruction to each address in the set of code addresses; and
store the modified codes in the one or more memory units; and
a second device including a processor, a memory unit for storing the modified codes, and one or more second programs stored in the memory unit, which, when executed by the processor, cause the second device to:
load the modified codes, wherein the modified codes are generated from the instructions using the function, including by injecting the reset instruction to each address in the set of code addresses identified as accessible from more than one address;
obtain extracted instructions from the modified codes by applying a reverse function of the function to the modified codes, including forgoing applying the reverse function to the reset instruction at each address in the set of code addresses; and
execute the extracted instructions.

16. The system of claim 15, wherein the function is a symmetric encryption function.

17. The system of claim 15, wherein the modified codes are generated by generating a second modified code corresponding to a second instruction, including applying the function to the second instruction and a first instruction.

18. The system of claim 17, wherein obtaining the extracted instruction from the modified codes includes obtaining the second instruction, including applying the reverse function to the second modified code and the first instruction.

19. The system of claim 15, wherein the modified codes are generated by:
determining whether or not an instruction is a first executed instruction; and
generating a modified code corresponding to the instruction by applying the function to the instruction and a pre-defined first instruction value.

20. The system of claim 19, wherein obtaining the extracted instructions includes:
obtaining the instruction by applying the reverse function to the modified code and the pre-defined first instruction value.
